(19) United States
(12) Patent Application Publication
(10) Pub. No.: US 2005/0217494 A1
(43) Pub. Date: Oct. 6, 2005

(54) Handling assembly

(76) Inventor: Christopher Hrushowy, Toronto (CA)

Correspondence Address: Louis Tessler, P.O. Box 54029, Town of Mount-Royal, QC, H3P 3H4, CA

(21) Appl. No.: 11/055,052

(22) Filed: Feb. 11, 2005

Related U.S. Application Data
(60) Provisional application No. 60/543,395, filed on Feb. 11, 2004.

(51) Int. Cl. A47J 37/12

(52) U.S. Cl. 99/413

(57) ABSTRACT

A handling assembly for allowing an intended user having hands to handle an object within a cooking vessel. The cooking vessel has a bottom wall and a peripheral wall extending substantially upwardly therefrom. The peripheral wall defines a rim. The handling assembly includes a plate for supporting the object, the plate being configured and sized so as to be receivable within the cooking vessel. The handling assembly further includes a handle removably attachable to the plate, the handle including an attachment section for removably attaching the handle to the plate.

The present Application claims priority from previously filed U.S. Provisional Patent Application Ser. No. 60/543,395 entitled “Implement for handling and supporting food or containers” filed on Feb. 11, 2004.

### FIELD OF THE INVENTION

The present invention relates to the general field of handling, and is particularly concerned with a handling assembly.

### BACKGROUND OF THE INVENTION

In some home cooking and canning procedures, containers containing food to be cooked or canned are disposed in a pot containing water. Then, heat is applied to the pot to boil the water. The boiling water, either through direct contact with the containers, or through indirect contact with the containers via steam, heats the containers and the food. When the food is cooked or sterilized, the containers are removed from the pot. However, the containers are usually at a temperature very close to the boiling temperature of water, and as such need to be handled with an implement by a user.

Often, the user wishes to handle a plurality of containers at once. In this case, the containers are typically disposed on a rack prior to being inserted into the pot. When the food is cooked or sterilized, the rack is lifted partially out of the pot and suspended on a rim of the pot to allow the containers to cool down before further handling. Typically, each prior art rack can only be used for pots of a given size. This requires that the user either buys a plurality of racks, or that the user always uses a pot of a given size, which can be sub-optimal depending on the number and size of containers.

Another disadvantage of commercially available racks resides in that they typically have handles that are not detachable. Therefore, these handles need to be receivable within the pot during the cooking or heating process. In addition, when it is desired to handle the racks, the handles are typically very hot, as they have been heated along with the food.

Against this background, there exists a need in the industry to provide a novel handling assembly.

### OBJECTS OF THE INVENTION

An object of the present invention is therefore to provide an improved handling assembly.

### SUMMARY OF THE INVENTION

In a broad aspect, the invention provides a handling assembly for allowing an intended user having hands to handle an object within a cooking vessel. The cooking vessel has a bottom wall and a peripheral wall extending substantially upwardly therefrom. The peripheral wall defines a rim. The handling assembly includes a plate for supporting the object, the plate being configured and sized so as to be receivable within the cooking vessel. The handling assembly further includes a handle removably attachable to the plate, the handle including an attachment section for removably attaching the handle to the plate.

Advantageously, having a detachable handle allows more flexibility in selecting the cooking vessel into which the plate is to be inserted. Also, detachable handles substantially reduce the risks of injuries that may happen when hot objects, such as permanently attached handles, are handled.

The handling assembly is relatively easy to manufacture and relatively inexpensive.

The handles allow hanging of the plate from the rim in a relatively stable manner. In some embodiments of the invention, the distance between the plate and the bottom wall is adjustable. Adjusting this distance further helps in the selection of a suitable cooking vessel.

In another broad aspect, the invention provides a handling kit including first and second plates and a handle removably attachable to the first and second plates.

Having two plates allows for the selection of the size of a cooking vessel to be used in conjunction with the handling kit as a function of a number of containers to be supported by the plate or as a function of the size of any other suitable object that is supportable onto the plate.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

An embodiment of the present invention will now be disclosed, by way of example, in reference to the following drawings in which:

FIG. 1: is a perspective view illustrating a handling assembly according to the invention, the handling assembly being hung to a rim of a cooking vessel;

FIG. 2 is a perspective view illustrating the handling assembly of FIG. 1;

FIG. 3 is a side elevation view illustrating the handling assembly of FIG. 1;

FIG. 4 is a front elevation view illustrating the handling assembly of FIG. 1;

FIG. 5 is a top elevation view illustrating the handling assembly of FIG. 1;

FIG. 6 is a perspective view illustrating a plate of the handling assembly of FIG. 1;

FIG. 7 is a top elevation view illustrating the plate of the handling assembly of FIG. 1;

FIG. 8 is a front elevation view illustrating the plate of the handling assembly of FIG. 1;

FIG. 9 is a side elevation view illustrating the plate of the handling assembly of FIG. 1;

FIG. 10 is a perspective view illustrating a handle component of the handling assembly of FIG. 1;

FIG. 11 is a side elevation view illustrating the handle component of the handling assembly of FIG. 1;

FIG. 12 is a front elevation view illustrating the handle component of the handling assembly of FIG. 1;

FIG. 13A is a top elevation view illustrating the handle component of the handling assembly of FIG. 1;

FIG. 13B is a top elevation view illustrating an alternative handle component;

FIG. 14 is a side elevation view of the attachment hook of the handle component of FIG. 10 in an open configuration;

FIG. 15 is a side elevation view of the attachment hook of the handle component of FIG. 10 in a retaining configuration;

FIG. 16 is a perspective view of a hanging section detachable component of the handle component of FIG. 10;

FIG. 17 is a perspective view of an alternative hanging section detachable component;

FIG. 18 is a side cross-section view of the hanging section detachable component of the handle component of FIG. 10;

FIG. 19 is a perspective view of a mobile grasping section component of the handle component of FIG. 10;

FIG. 20 is a side cross-section of the mobile grasping section component of the handle component of FIG. 10;

FIG. 21 is a side elevation view of a portion of the plate of FIG. 6; and

FIG. 22 is a side elevation view of a portion of an alternative plate.

### DETAILED DESCRIPTION

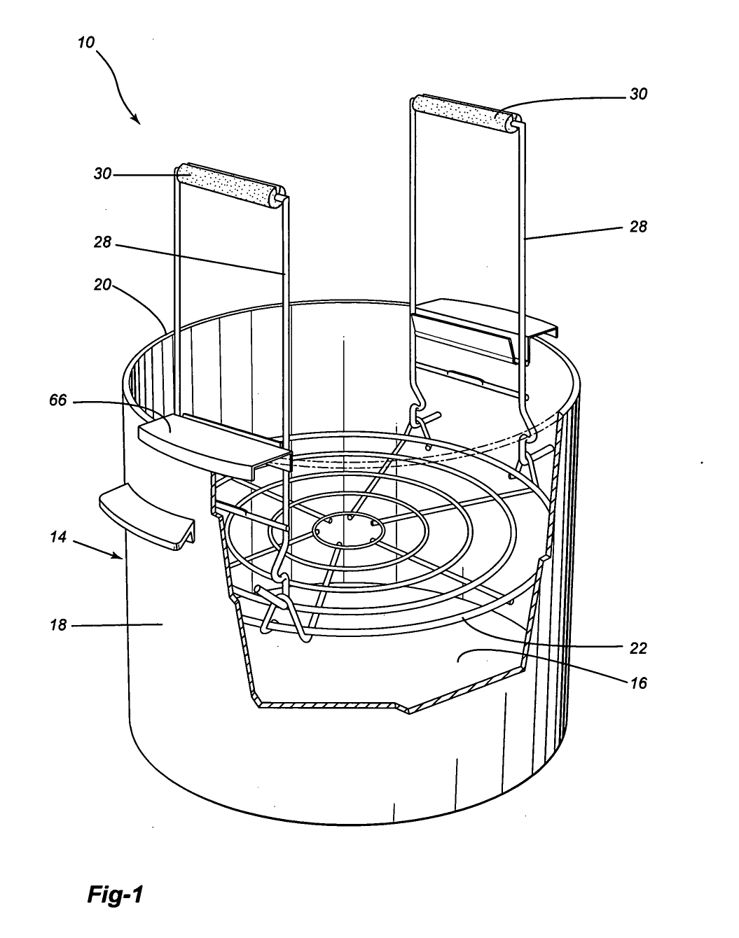

FIG. 1 illustrates a handling assembly 10 for allowing an intended user having a hand (not shown in the drawings) to handle an object 12 (not shown in FIG. 1) within a cooking vessel 14. The cooking vessel 14 has a bottom wall 16, a peripheral wall 18 extending substantially upwardly from the bottom wall 16 and a rim 20 defined by the peripheral wall 18.

The handling assembly 10 includes a plate 22 for supporting the object 12. The plate 22 is configured and sized so as to be receivable within the cooking vessel 14. A handle is removably attachable to the plate 22. The handle includes an attachment section for removably attaching the handle to the plate 22.

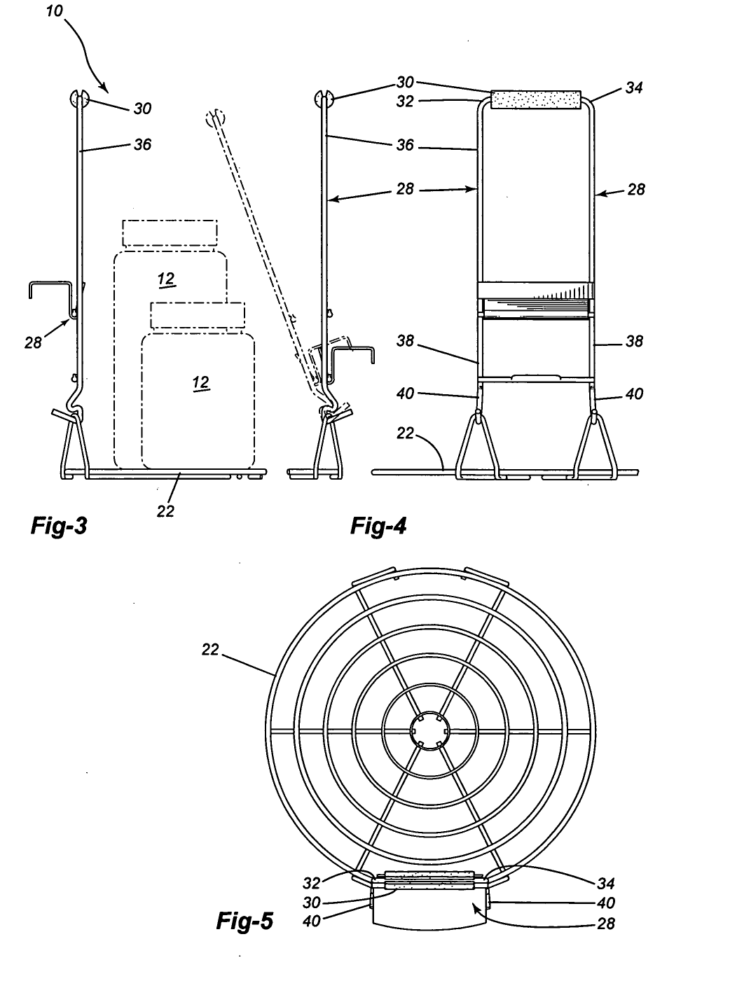

The object 12 shown in FIG. 3 is a container used in a canning process. However, the handling assembly 10 is suitable for handling any other suitable object that the intended user may wish to heat within the cooking vessel 14. Examples of such objects include any other object to sterilize or food items to cook, such as lobsters or corn on the cob.

The detachable handle allows heating the object 12 within the cooking vessel 14 without requiring that the handle be attached to the plate 22. When it is desired to handle the object 12, the handle 24 is attached to the plate 22 and therefore allows manipulating the object 12.

Also, in some embodiments of the invention, there is provided a handling kit for allowing the intended user to handle the object 12 within first and second cooking vessels. The first and second cooking vessels have respective bottom walls and respective peripheral walls extending substantially upwardly from their respective bottom walls. Each respective peripheral wall defines a respective rim.

The handling kit includes first and second plates, each for supporting the object. A handle is removably attachable to the first and second plates. The first and second plates are substantially circular and of differing diameters. This allows for insertion of the first and second plates within cooking vessels having differing diameters. Indeed, the reader skilled in the art will readily appreciate that in some embodiments of the invention there is an advantages to have plates that are of a diameter substantially identical to a diameter of a cooking vessel that is in use. Also, the reader skilled in the art will readily appreciate that it is within the scope of the invention to have handling kit that include more than two plates. Since the first and second plates are substantially similar to the plate 22, they will not be described in further details herein.

However, it is within the scope of the invention to have handling assemblies including any suitable number of handles.

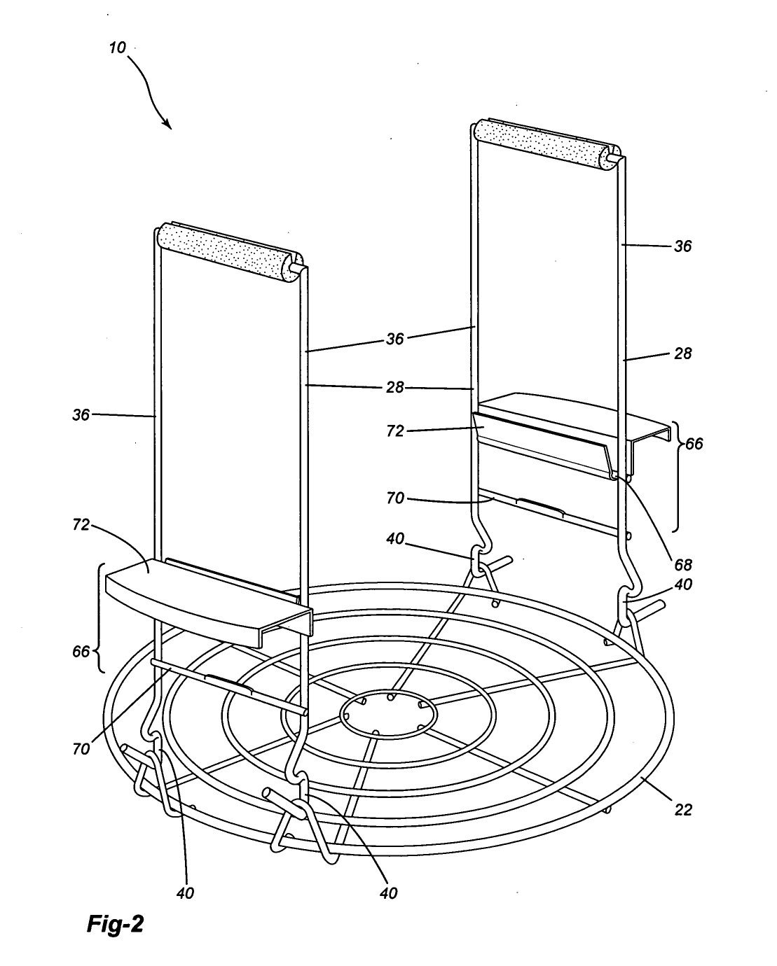

As illustrated in FIGS. 2 and 3, in some embodiments of the invention, the handle of the handling assembly 10 includes a pair of handle components 28. At least one of the handle components 28 is removably attachable to the plate 22. In the embodiment of the invention shown in the drawings, both handle components 28 are removably attachable to the plate 22. However, it is within the scope of the claimed invention to any other suitable handle.

FIGS. 3, 4 and 5 illustrate one of the handling components 28 and its attachment to the plate 22. The handling components 28 include a grasping section 30 graspable by the hand of the intended user. The grasping section defines a pair of substantially opposed grasping section longitudinal ends 32 and 34 (shown in FIGS. 4 and 5).

A pair of spacing sections 36 (better shown in FIG. 4) extends substantially perpendicularly from the grasping section 30 substantially adjacent a respective one of the grasping section longitudinal ends 32 and 34. The spacing sections 36 each define a spacing section distal end 38. The attachment section includes a pair of attachment hooks 40 provided substantially adjacent a respective one of the distal ends 38. In some embodiments of the invention, each of the attachment hooks 40 extends integrally from a respective one of the spacing sections 36.

Therefore, in the embodiment of the invention shown in the drawings, the attachment hooks 40 are substantially opposite the grasping section 30. This allows a maximal distance between the object to handle and the grasping section 30, which is advantageous in cases wherein the object 12 is relatively hot or in situations wherein the cooking vessel 14 is filled with relatively hot or boiling water.

As better seen in FIGS. 10 and 11, and as partially illustrated by FIG. 12, each of the attachment hooks 40 includes a hook abutting segment 42 for supporting the plate 22, a hook retaining segment 44 for stabilizing the plate 22 while it is supported by the hook abutting segment 42 and a hook abutting-to-retaining segment 46 connecting the hook retaining and abutting segments 42 and 44. A linking segment 48 connects the hook retaining segment 44 to the spacing section 36. However, it is within the scope of the invention to have handle components 28 that is attachable to the plate 22 in any other suitable manner.

The hook abutting segment 42 and the hook retaining segment 44 extend substantially radially outwardly when the handle component 28 is attached to the plate 22, as seen from FIG. 3. Also, the hook abutting segment 42 is angled so as to extend substantially downwardly in a generally inward radial direction. The reader skilled in the art will readily appreciate that these two characteristics are not necessarily present in alternative embodiments of the claimed invention.

The hook abutting segment 42, the hook retaining segment 44 and the hook abutting-to-retaining segment 46 define a recess 50.

In some embodiments of the invention, a length of the retaining segment 44 is substantially smaller than the length of the abutting segment 42 so as to facilitate the attachment of the handle component 28 to the plate 22. However, in alternative embodiments of the invention, a length of the retaining segment 44 is substantially equal to or smaller than the length of the abutting segment 42.

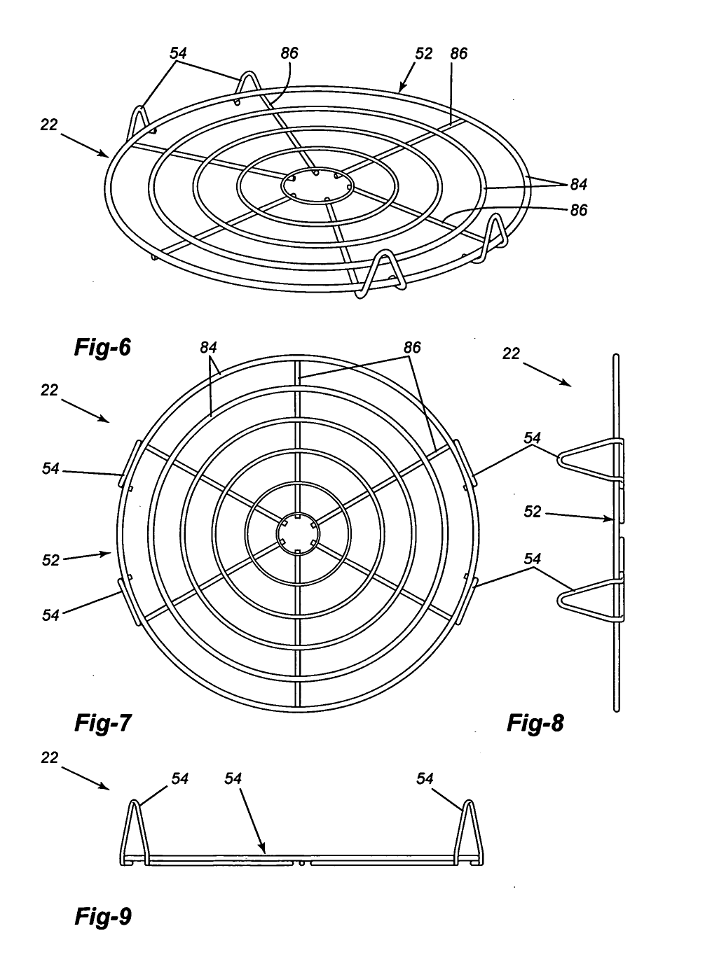

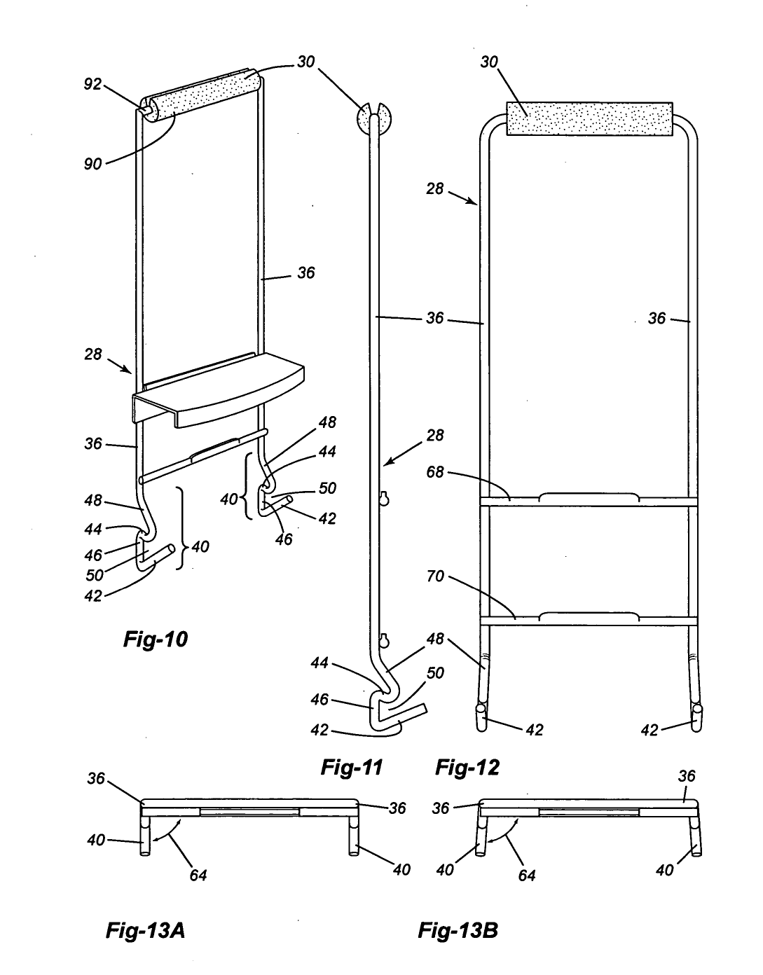

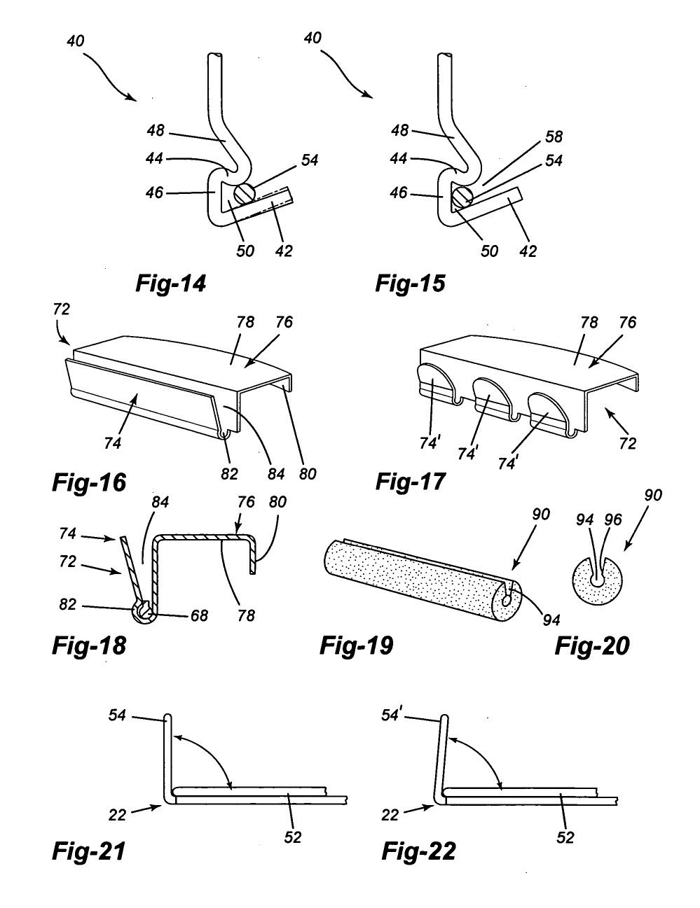

As shown in FIGS. 6, 7, 8 and 9, the plate 22 includes a plate base 52 and two pairs of plate hooks 54; the plate hooks 54 extending substantially upwardly from the plate base 52. The attachment hooks 40 and the plate hooks 54 are substantially complementarily configured and sized so that the plate hooks 54 are each receivable between a corresponding hook retaining segment 42 and a hook abutting segment 44. Therefore, the plate hooks 54 are receivable at least in part within the recess 50, as illustrated in FIGS. 14 and 15 and further discussed hereinbelow.

The hook abutting segment 42 and the hook retaining segments 44 define a hook opening 58 therebetween, the hook opening 58 leading into the recess 50. The hook abutting and retaining segments 42 and 44 are substantially converging towards each other at the hook opening 58.

The hook opening 58 is resiliently deformable between an open configuration and a retaining configuration. FIG. 14 illustrates the open configuration while FIG. 15 illustrates the retaining configuration.

In the open configuration, the plate hook 54 is insertable into the recess 50 through the opening 58. In the retaining configuration, the plate hook 54 is retained within the recess 50.

Therefore, inserting the plate hook 54 into the recess 50, or removing the plate hook 54 from the recess 50, requires the exertion of a force by the intended user on the handle component 28. The downward orientation of the hook abutting segment 42 in a generally radially inward direction helps to facilitate the insertion of the plate hook 54 into the opening 50. Indeed, under the influence of gravity, the object 12 produces a force that tends to push the plate hook 54 into the opening 50 upon the handle component 28 being lifted.

As illustrated in FIGS. 13A and 13B, the spacing sections 36 define a spacing section plane. The attachment hooks 40 each define a respective attachment hook plane. The spacing and attachment hook planes are angled at an attachment-hook-plane-to-spacing-section-plane angle 64. In some embodiments of the invention, as shown in FIG. 13B, the attachment-hook-plane-to-spacing-section-plane-angle is of from about 90° to about 105°. In very specific examples of implementation shown in FIG. 13A, the attachment-hook-plane-to-spacing-section-plane angle 64 is of about 90°. In another specific embodiment of the invention, the attachment-hook-plane-to-spacing-section-plane angle is of about 95°.

In embodiments of the invention wherein the attachment-hook-plane-to-spacing-section-plane angle is larger than 90°, this angle helps in stabilizing the plate 22 when the plate 22 is attached to the handling components 28, as described in further details hereinbelow.

As better shown in FIG. 1, in some embodiments of the invention, the handle component 28 includes a hanging section 66 for allowing hanging of the handle components 28 to the rim 20 so that the plate 22 is spaced from the bottom wall 16. The hanging section 66 allows for a variable positioning of the plate 22 with respect to the bottom wall 16.

More specifically, the hanging section 66 is configured and sized so as to allow for the supporting of the handle components 28 in an upper configuration wherein the plate 22 is at a first distance from the bottom wall 16 and in a lower configuration wherein the plate 22 is at a second distance from the bottom wall 16. The second distance from the bottom wall is substantially smaller than the first distance from the bottom wall.

Accordingly, the hanging section 66 allows for suspending the plate 22 at a variable distance over the bottom wall 16. This allows for flexibility in selecting the cooking vessel 12 as a single handling component 28 is suitable for use with peripheral walls extending over varying distances upwardly from the bottom wall.

As better shown in FIG. 2, the hanging section 66 includes a proximal hanging section attachment 68 extending between the first and second spacing section 36. The hanging section 66 further includes a distal hanging section attachment 70 extending between the first and second spacing sections 36. A hanging section detachable component 72 removably attaches to each one of the proximal and distal hanging section attachments 68 and 70. The hanging section detachable component 72 is better illustrated in FIGS. 16 and 18.

The hanging section detachable component 72 includes a clip 74 for clipping the hanging section detachable component 72 to the proximal and distal hanging sections attachment 68 and 70. In addition, the hanging section detachable component 72 includes a supporting section 76 extending from the clip 74. The support section 76 allows supporting of the hanging section detachable component 72 onto the rim 20.

In some embodiments of the invention, the support section 76 includes a substantially flat top wall 78 and a substantially curved lateral wall 80 extending substantially downwardly therefrom. The lateral wall 80 is curved so as to substantially conform to the shape of the rim 20 of the cooking vessel 12.

The clip 74 extends from the top wall 78 substantially opposite the lateral wall 80. The clip 74 defines a clip recess 82 for receiving thereinto the proximal and distal hanging section attachments 68 and 70. The clip 74 further defines a clip opening 84 leading into the clip recess 82. The clip 74 is substantially resilient such as to allow the insertion thereinto of the proximal and distal hanging section attachments 68 and 70. In addition, in some embodiments of the invention, the clip opening 84 is of a dimension substantially smaller than the proximal and distal hanging section attachments 68 and 70 so as to secure the clip 74 thereto.

FIG. 17 illustrates an alternative hanging section detachable component 72′ including three substantially collinear clips 74′ to attach the hanging section detachable component 72′ to the proximal and distal hanging section attachments 68 and 70. The clips 74′ then replace the clip 74. The reader skilled in the art will readily appreciate that the hanging section detachable component 72 takes any other suitable form in alternative embodiments of the invention.

In some embodiments of the invention, each of the proximal and distal support sections 68 and 70 includes a substantially rectilinear wire for clipping the clip 74 thereto.

The plate base 12 includes a plurality of concentric circular wires 84 interconnected to a plurality of substantially radial connecting wires 86. In some embodiments of the invention, the plate hooks 54 extend integrally from the connecting wires 86 and are formed by bending a substantially rectilinear wire. However, it is within the scope of the invention to have any plates 12 taking any other suitable form.

The plate hooks 54 are substantially triangular and provided substantially peripherally to the plate base. As shown in FIG. 21, the plate hooks 54 are angled substantially radially inwardly and angled at from about 75° to about 85° with respect to the base plate 22. FIG. 22 illustrates an alternative embodiment of the invention, wherein plate hooks 54′ are substantially perpendicular to the base plate 52 of an alternative plate 22′. However, in other alternative embodiments of the invention, the plate hooks are angled at any other suitable angle with respect to the plate base 12.

In some embodiments of the invention, the grasping section 30 is of a width substantially similar to the width of the hand of the intended user. In a specific example of the invention, as shown for example in FIG. 3, the grasping section 30 includes a mobile grasping section component 90 rotatably mounted with respect to the spacing sections 36 through a grasping section axle 92 between the spacing sections 36.

As seen in FIGS. 19 and 20, the mobile grasping section component 90 defines a groove 94 extending therein for receiving the grasping section axle 92. The groove 94 defines therewithin two ridges 96 extending substantially inwardly within the groove 94. The mobile grasping section component 90 is substantially resilient so as to allow clipping of the mobile grasping section component 90 onto the grasping section axle 92.

In use, the plate 22 is disposed onto the bottom wall 16. Then, the object 12 is inserted within the cooking vessel and onto the plate 22. Further to this setup, the object is cooked, warmed, sterilized or otherwise heated as required. When it is required that the object 12 be removed from the cooking vessel 14, the handle components 28 are attached to the plate 22 through the attachment section 26. The radially inward orientation of the plate hooks 54 allow for space to be left between the plate 22 and the peripheral wall 18 to attach the attachment hooks 40 to the plate hooks 54 even if the 1 is of a diameter substantially identical to a diameter of the cooking vessel 14.

In addition, the slightly angled configuration of the abutting segment 42 causes the attachment hooks 40 to engage the plate hooks 54 upon the handle component being lifted if the plate hooks 54 abut the abutting segment 42.

Subsequently, the user has a choice of completely moving the plate 22 out of the cooking vessel, or to suspend the plate 22 above the bottom wall 16 through the use of the hanging section 66. In this case, the hanging section removable component 72 has been attached to either the proximal or distal hanging section attachments 68 and 70 to be thereafter suspended onto the rim 20.

Although the present invention has been described hereinabove by way of preferred embodiments thereof, it can be modified, without departing from the spirit and nature of the subject invention as defined in the appended claims.

1. A handling assembly for allowing an intended user having a hand to handle an object within a cooking vessel, the cooking vessel having a bottom wall and a peripheral wall extending substantially upwardly therefrom, the peripheral wall defining a rim, said handling assembly comprising:
a. a plate for supporting the object, said plate being configured and sized so as to be receivable within the cooking vessel;
b. a handle removably attachable to said plate, said handle including an attachment section for removably attaching said handle to said plate.

2. A handling assembly as defined in claim 1, wherein:
a. said handle includes a pair of handle components, at least one of which is removably attachable to said plate;
b. said at least one handle component includes
i. a grasping section graspable by the hand, said grasping section defining a pair of substantially opposed grasping section longitudinal ends; and
ii. a pair of spacing sections extending substantially perpendicularly from said grasping section substantially adjacent a respective one of said grasping section longitudinal ends, said spacing sections each defining a spacing section distal end; and
c. said attachment section includes a pair of attachment hooks provided substantially adjacent a respective one of said distal ends.

3. A handling assembly as defined in claim 2, wherein each of said attachment hooks includes a hook abutting segment for supporting said plate upon, a hook retaining segment for stabilizing said plate while it is supported by said hook abutting segment and a hook abutting-to-retaining segment connecting said hook retaining and abutting segments.

4. A handling assembly as defined in claim 3, wherein said hook abutting segment extends substantially downwardly in a generally inward radial direction.

5. A handling assembly as defined in claim 4, wherein a length of said retaining segment is substantially smaller than a length of said abutting segment.

6. A handling assembly as defined in claim 3, wherein said plate includes a plate base and a pair of plate hooks extending substantially upwardly from said plate base, said attachment hooks and said plate hooks being substantially complementarily configured and sized so that said plate hooks are each receivable between a corresponding hook retaining segment and a hook abutting segment.

7. A handling assembly as defined in claim 6, wherein said hook abutting segment and said hook retaining segment together define a hook opening therebetween leading into said recess, said hook abutting and retaining segments substantially converging towards each other at said hook opening.

8. A handling assembly as defined in claim 7, wherein said hook abutting segment is angled so as to extend substantially downwardly in a generally inward radial direction.

9. A handling assembly as defined in claim 7, wherein:
a. said hook opening is resiliently deformable between an open configuration and a retaining configuration;
b. in said open configuration said plate hook is insertable into said recess through said opening; and
c. in said retaining configuration, said plate hook is retained within said recess.

10. A handling assembly as defined in claim 2, wherein:
a. said pair of spacing sections defines a spacing section plane;
b. each of said attachment hooks defines a respective attachment hook plane;
c. said spacing and attachment hook planes are angled at an attachment-hook-plane-to-spacing-section-plane angle; and
d. attachment-hook-plane-to-spacing-section-plane angle is of from about 90 degrees to about 105 degrees.

11. A handling assembly as defined in claim 11, wherein said attachment-hook-plane-to-spacing-section-plane angle is of about 95 degrees.

12. A handling assembly as defined in claim 2, wherein said at least one handle component includes a hanging section for allowing to hang said at least one handle component to said rim so that said plate is spaced apart from the bottom wall.

13. A handling assembly as defined in claim 12, wherein said hanging section allows for variable positioning of said plate with respect to the bottom wall.

14. A handling assembly as defined in claim 13, wherein said hanging section is configured and sized so as to allow supporting said handle in an upper configuration wherein said plate is at a first distance from the bottom wall and in a lower configuration wherein said plate is at a second distance from the bottom wall, the second distance from the bottom wall being substantially larger than the first distance from the bottom wall.

15. A handling assembly as defined in claim 14, wherein said hanging section includes:
a. a proximal hanging section attachment extending between said first and second spacing sections;
b. a distal hanging section attachment extending between said first and second spacing sections; and
c. a hanging section detachable component removably attachable to each one of said proximal and distal hanging section attachments;
d. wherein in said upper configuration, said hanging section detachable component is attached to said distal hanging section attachment and in said lower configuration, said hanging section detachable component is attached to said proximal hanging section attachment.

16. A handling assembly as defined in claim 15, wherein said hanging section detachable component includes a clip for clipping said hanging section detachable component to said proximal and distal hanging section attachments.

17. A handling assembly as defined in claim 16, wherein each of said proximal and distal support section attachment includes a substantially rectilinear wire for clipping said clip thereto.

18. A handling assembly as defined in claim 6, wherein each of said attachment sections extends integrally from a respective one of said spacing sections.

19. A handling assembly as defined in claim 6, wherein said plate hooks are substantially triangular.

20. A handling assembly as defined in claim 19, wherein:
a. said plate hooks are angled substantially radially inwardly;
b. and said plate hooks are angled at from about 75 degrees to about 85 degrees with respect to said plate base.

21. A handling assembly as defined in claim 6, wherein said plate base includes a plurality of concentric circular wires interconnected through a plurality of substantially radially oriented connecting wires.

22. A handling assembly as defined in claim 21, wherein said plate hooks are provided substantially peripherally to said plate base.

23. A handling assembly as defined in claim 1, wherein said grasping section is of a width substantially similar to a width of the hand of the intended user.

24. A handling assembly as defined in claim 2, wherein said grasping section includes a mobile grasping section component rotatably mounted with respect to said spacing sections through a grasping section axle extending between said spacing sections.

25. A handling kit for allowing an intended user having a hand to handle an object within a first and a second cooking vessel, each of the first and second cooking vessel having a respective bottom wall and a respective peripheral wall extending substantially upwardly therefrom, each respective peripheral wall defining a respective rim, said handling kit comprising:
a. first and second plates each for supporting the object, said first plate being configured and sized so as to be receivable within the first cooking vessel, said second plate being configured and sized so as to be receivable within the second cooking vessel; and
b. a handle removably attachable to said first and said second plates, said handle including an attachment section for removably attaching said handle to said first and second plates;
c. wherein the first and second cooking vessels are of differing diameter, said first and second plates also being of differing diameters.
